(19) United States
(12) Patent Application Publication
(10) Pub. No.: US 2022/0149646 A1
(43) Pub. Date: May 12, 2022

(54) 22-COIL WIRELESS CHARGING DEVICE CAPABLE OF CHARGING FOR THREE DEVICES SIMULTANEOUSLY

(71) Applicant: Linwei Yang, Zhongshan (CN)

(72) Inventor: Linwei Yang, Zhongshan (CN)

(21) Appl. No.: 17/149,770

(22) Filed: Jan. 15, 2021

(30) Foreign Application Priority Data
Nov. 10, 2020 (CN) 202011247106.3

(51) Int. Cl. H02J 7/02; H01F 38/14; H02J 7/00; H02J 50/40; H02J 50/10

(52) U.S. Cl. CPC H02J 7/02; H01F 38/14; H02J 7/0047; H02J 2207/20; H02J 7/00032; H02J 50/402; H02J 50/10; H02J 7/0042

(57) ABSTRACT

The invention discloses a 22-coil wireless charging device capable of charging for three devices simultaneously, comprising a bottom case, an upper cover, a PCB main control board, and a coil block; wherein the coil block comprises a coil carrier board and at least two layers of coil circuit groups; the coil circuit groups are divided into 3 groups of coil circuit units. The invention uses the principle of electromagnetic induction to realize wireless charging; 22 coils are used in a multi-layer overlapping and array layout; the charged device can be placed at will. The inverter network circuit group enables it possible to select and control whether the coil works, avoiding dangers and communication crosstalk. The charging device is provided with voltage, current, temperature, brightness and other sampling and monitoring circuits to automatically monitor the working status in real time to ensure the safety and stability of the system during operation.

### BACKGROUND OF THE INVENTION

### 1. Field of the Invention

The invention relates to the field of wireless charging, in particular to a 22-coil wireless charging device capable of charging for three devices simultaneously, and the device can be placed at will in the charging area for charging without blind spots.

### 2. Description of the Related Art

Wireless charging, also known as induction charging and non-contact induction charging, uses the principle of electromagnetic induction to set a coil at the transmitting end and the receiving end; the transmitting end coil sends out electromagnetic signals to the outside under the action of electric power, and the receiving end coil receives the electromagnetic signals to induce each other to induce electromagnetic induction, which converts electromagnetic energy into induced voltage, so as to achieve the purpose of wireless charging. The wireless charging technology does not require a power cord and relies on electromagnetic induction to convert electromagnetic energy into electrical energy, and finally realize wireless charging. The wire charging technology solves the wire bondage between the charger and the device; there is no need for wire connection, no need for the charging contacts to be exposed, which avoids contact wear and short circuits. The wireless charging has good waterproof and dustproof properties, and is durable. Most of the current universal wireless charging devices are based on the Qi protocol and follow the Qi protocol's one-to-one charging method; it is required that the coils should be aligned as much as possible, and the coils should be as close as possible; it is difficult to find the position, and the best charging position needs to be searched for many times; the charging efficiency is low, and the charging of multiple devices cannot be realized simultaneously.

### SUMMARY OF THE INVENTION

In order to solve the above technical problems, the technical solutions provided by the invention are: a 22-coil wireless charging device capable of charging for three devices simultaneously, comprising a bottom case and an upper cover that are provided oppositely, a PCB main control board provided in the bottom case, and a coil block provided on the PCB main control board and electrically connected thereto; wherein the coil block comprises a coil carrier board and at least two layers of coil circuit groups stacked on the coil carrier board; the coil circuit groups are divided into 3 groups of coil circuit units along the length direction of the charging device;
the PCB main control board is provided with an MCU main control circuit, a power input circuit electrically connected to the MCU main control circuit, an auxiliary power supply circuit, a temperature sampling circuit, an LED indicator circuit, an ambient light monitoring circuit, and multiple groups of inverter network circuit groups corresponding to the coil units one-to-one; the inverter network circuit group comprises an inverter network circuit connected to the coil circuit unit, an inverter circuit input current sampling circuit, an inverter circuit input voltage sampling circuit, a coil voltage sampling circuit, a coil current sampling circuit, a demodulation circuit, a coil selection circuit, and a synchronous DC voltage adjustment circuit;
when the charged device is magnetically coupled on the charging device, the inverter network circuit corresponds to each coil in the corresponding coil circuit unit, and samples the real-time parameters of each coil through the inverter circuit input current sampling circuit and the inverter circuit input voltage sampling circuit and outputs signals to the MCU main control circuit before energy transmission; the MCU main control circuit controls the coil with the strongest magnetic field coupling capability of the charged device for energy transmission through the coil selection circuit; at the same time, the coil voltage sampling circuit and the coil current sampling circuit sample parameters of the working coils and output signals to the MCU main control circuit; the demodulation circuit extracts the carrier communication signal attached to the coil voltage and sends it to the MCU main control circuit; the synchronous DC voltage adjustment circuit adjusts the voltage on the input of the inverter network circuit through the PWM control output of the MCU main control circuit.

As an improvement, the coil circuit group is provided with 22 coils in total; after being divided into 3 groups of coil circuit units, each group of coil circuit units sequentially contains 8, 8, and 6 coils, and the adjacent ends of each group of coil circuit units are provided with overlapping areas.

As an improvement, the input end of the power input circuit is provided with a Type-c interface, and a communication protocol is proceed with a power adapter through a PD chip.

As an improvement, the auxiliary power circuit reduces the voltage provided by the power input circuit to 3.3V through a DC-DC chip, and provides power for the temperature sampling circuit, the LED indicator circuit, the ambient light monitoring circuit, and multiple inverter network circuit groups.

As an improvement, the temperature sampling circuit samples the temperature in the bottom case and the upper cover through several thermistors and transmits the temperature signal to the MCU main control circuit.

As an improvement, the LED indicator circuit is provided with several status indicators, and the status indicators are embedded on the side wall of the bottom case.

As an improvement, the ambient light monitoring circuit collects the ambient light source through several photoresistors and transmits the light source signal to the MCU main control circuit, and the MCU main control circuit sends a light brightness adjustment signal to the LED indicator circuit according to the light source signal.

As an improvement, the inverter network circuit is a full bridge inverter network circuit composed of two half bridges.

As an improvement, the coil carrier board is connected to the PCB main control board through self-tapping screws, and the PCB main control board is connected to the bottom case through self-tapping screws; the outer surface of the bottom case is further provided with several silica gel filler strips.

As an improvement, the status indicators are provided on the side wall of the bottom case through a sponge pad.

After adopting the above structure, the invention has the following advantages.

The wireless charging device of the invention uses the principle of electromagnetic induction to realize wireless charging; inside the device, 22 coils are used in a multi-layer overlapping and array layout. In the charging area, the charged device does not need to be aligned to a certain position, and can be placed at will; there is almost no blind spots for charging; the 22-coil wireless charging device simultaneously supports charging of 3 Qi charging devices (such as mobile phones, watches, earphones, etc.) in the charging area without blind spots. Through the setting of the inverter network circuit group, it is possible to select and control whether the coil works, which avoids dangerous situations, and avoids communication crosstalk when two devices are working; through the setting of multiple temperature sampling circuits, the device has a comprehensive temperature detection capability. When the charged device is abnormal and the temperature is too high, the charging system can be automatically shut down to effectively protect the charging dock and the charged device. The charging device is provided with multiple voltage, current, temperature, brightness and other sampling and monitoring circuits to automatically monitor the working status in real time to ensure the safety and stability of the system during operation.

### BRIEF DESCRIPTION OF THE DRAWINGS

FIG. 1 is a schematic structural diagram of the 22-coil wireless charging device capable of charging for three devices simultaneously according to the invention.

FIG. 2 is a schematic diagram of the sections of the coil circuit groups in the 22-coil wireless charging device capable of charging for three devices simultaneously according to the invention.

FIG. 3 is a schematic diagram of the system module of the coil circuit group in the 22-coil wireless charging device capable of charging for three devices simultaneously according to the invention.

FIG. 4 is a schematic diagram of a group of coil circuit units in the 22-coil wireless charging device capable of charging for three devices simultaneously according to the invention.

FIG. 5 is a schematic diagram of the power input circuit of the 22-coil wireless charging device capable of charging for three devices simultaneously according to the invention.

FIG. 6 is a schematic diagram of the auxiliary power circuit of the 22-coil wireless charging device capable of charging for three devices simultaneously according to the invention.

FIG. 7 is a schematic diagram of the inverter network circuit of the 22-coil wireless charging device capable of charging for three devices simultaneously according to the invention.

FIG. 8 is a schematic diagram of the voltage adjustment DC-DC circuit of the 22-coil wireless charging device capable of charging for three devices simultaneously according to the invention.

FIG. 9 is a schematic diagram of the MCU main control circuit of the 22-coil wireless charging device capable of charging for three devices simultaneously according to the invention.

FIG. 10 is a schematic diagram of the temperature sampling circuit diagram of the 22-coil wireless charging device capable of charging for three devices simultaneously according to the invention.

FIG. 11 is a schematic diagram of the LED indicator circuit of the 22-coil wireless charging device capable of charging for three devices simultaneously according to the invention.

FIG. 12 is a schematic diagram of the coil selection circuit of the 22-coil wireless charging device capable of charging for three devices simultaneously according to the invention.

FIG. 13 is a schematic diagram of the coil voltage sampling circuit of the 22-coil wireless charging device capable of charging for three devices simultaneously according to the invention.

FIG. 14 is a schematic diagram of the coil current sampling circuit of the 22-coil wireless charging device capable of charging for three devices simultaneously according to the invention.

FIG. 15 is a schematic diagram of the inverter circuit input current sampling circuit of the 22-coil wireless charging device capable of charging for three devices simultaneously according to the invention.

FIG. 16 is a schematic diagram of the inverter circuit input voltage sampling circuit of the 22-coil wireless charging device capable of charging for three devices simultaneously according to the invention.

FIG. 17 is a schematic diagram of the demodulation circuit of the 22-coil wireless charging device capable of charging for three devices simultaneously according to the invention.

FIG. 18 is a schematic diagram of the coil circuit unit of the 22-coil wireless charging device capable of charging for three devices simultaneously according to the invention.

FIG. 19 is a schematic diagram of the synchronous DC voltage adjustment circuit of the 22-coil wireless charging device capable of charging for three devices simultaneously according to the invention.

### DETAILED DESCRIPTION OF THE PREFERRED EMBODIMENTS

In order to make the objectives, technical solutions, and advantages of the embodiments of the invention clearer, the technical solutions in the embodiments of the invention will be described clearly and completely hereinafter with reference to the drawings in the embodiments of the invention. Obviously, the described embodiments are part of the embodiments of the invention, rather than all of the embodiments.

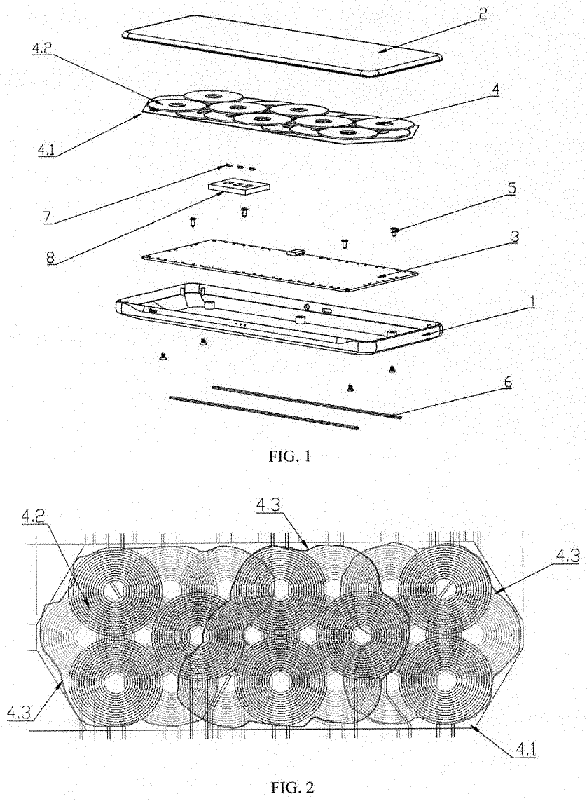

With reference to FIGS. 1 and 2, a 22-coil wireless charging device capable of charging for three devices simultaneously, comprising a bottom case 1 and an upper cover 2 that are provided oppositely, a PCB main control board 3 provided in the bottom case 1, and a coil block 4 provided on the PCB main control board 3 and electrically connected thereto; wherein the coil block 4 comprises a coil carrier board 4.1 and at least two layers of coil circuit groups 4.2 stacked on the coil carrier board 4.1; in order to realize the free placement of the device, the coil circuit group 4.2 of the device is provided with 22 coils in total; the coil circuit groups 4.2 are divided into 3 groups of coil circuit units 4.3 along the length direction of the charging device; each group of coil circuit units 4.3 sequentially contains 8, 8, and 6 coils, and the adjacent ends of each group of coil circuit units 4.3 are provided with overlapping areas, which enables that the coils in each layer of the coil circuit groups are arranged regularly in an array, and each coil is arranged in the blind spots of the dead zone of its adjacent coil.

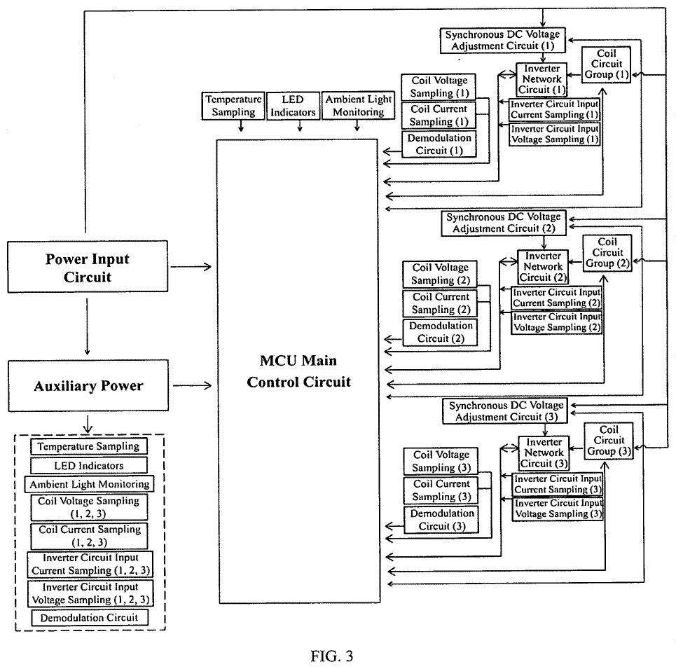

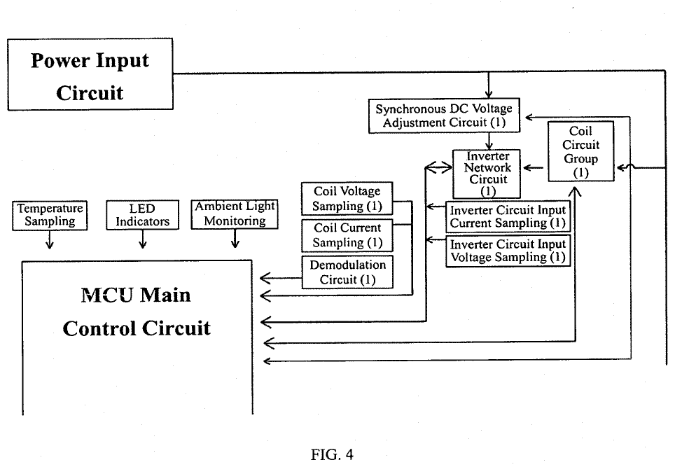

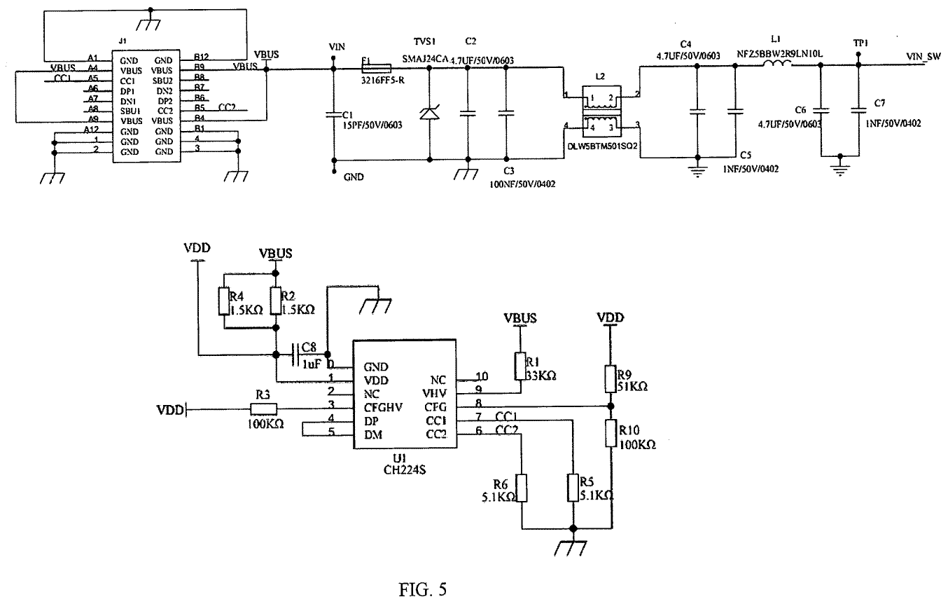

With reference to FIGS. 3 and 4, the PCB main control board 3 is provided with an MCU main control circuit, a power input circuit electrically connected to the MCU main control circuit, an auxiliary power supply circuit, a temperature sampling circuit, an LED indicator circuit, an ambient light monitoring circuit, and multiple groups of inverter network circuit groups corresponding to the coil units one-to-one; the inverter network circuit group comprises an inverter network circuit connected to the coil circuit unit, an inverter circuit input current sampling circuit, an inverter circuit input voltage sampling circuit, a coil voltage sampling circuit, a coil current sampling circuit, a demodulation circuit, a coil selection circuit, and a synchronous DC voltage adjustment circuit;
with reference to FIG. 5, the input end of the power input circuit is provided with a Type-c interface, with a maximum input of 20V/2.25 A/45 w, and a communication protocol is proceed with a power adapter through a PD chip WT6616 to provide suitable power for different functional modules subsequently;

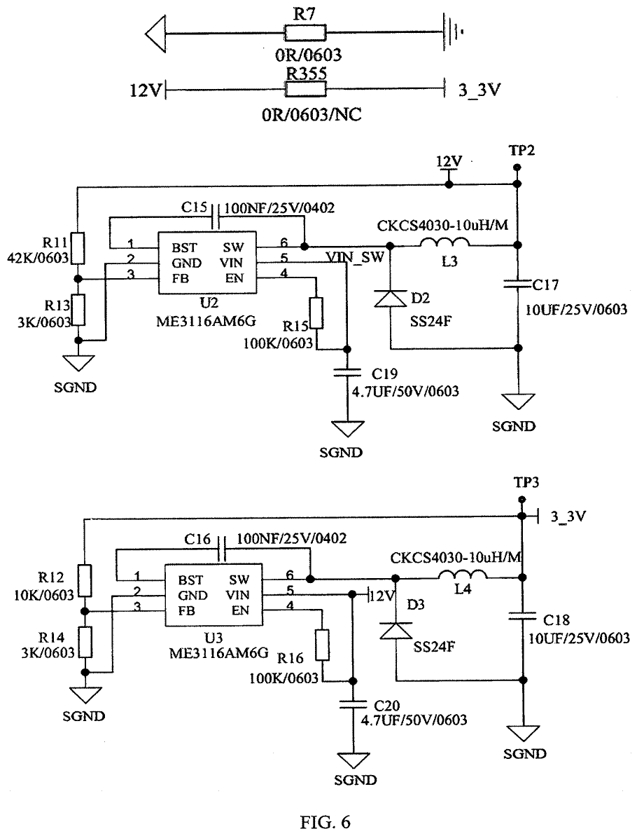

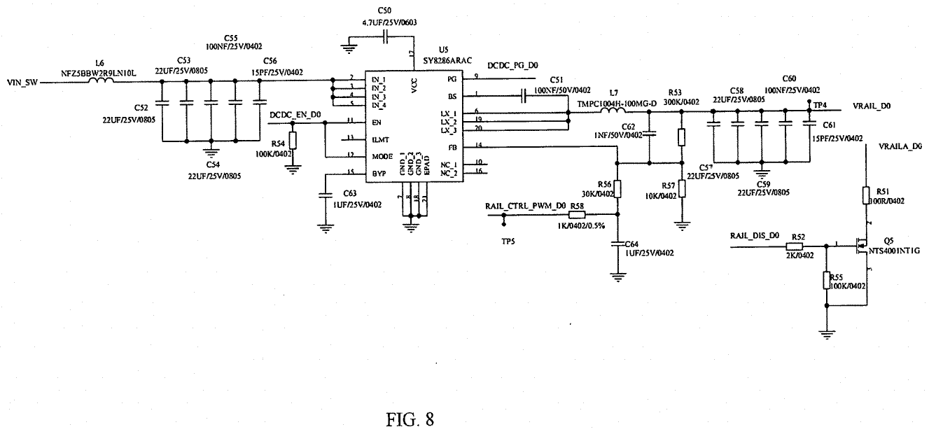

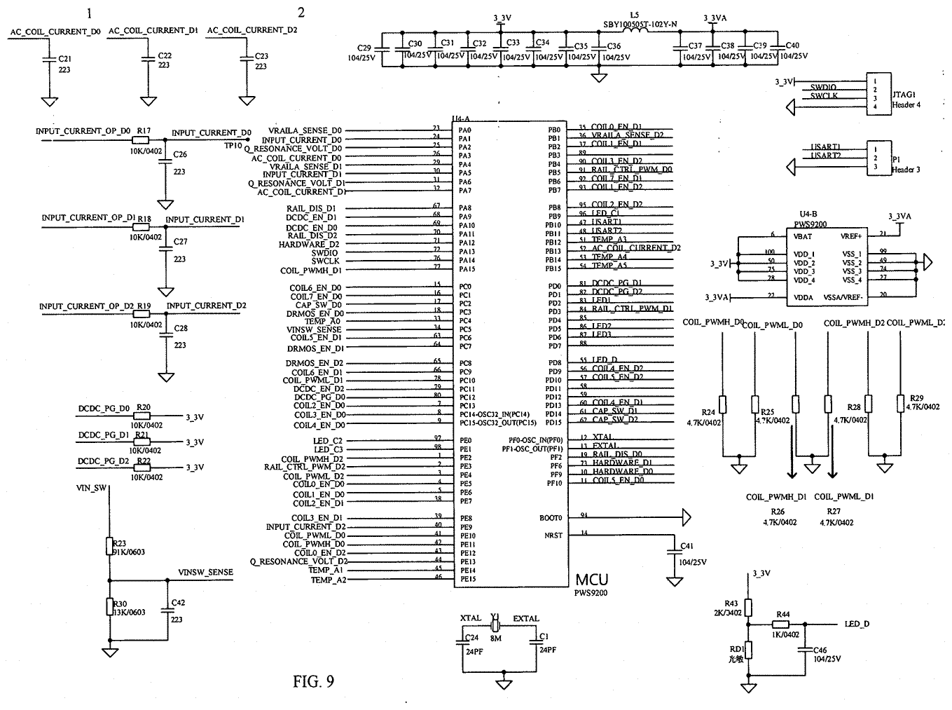

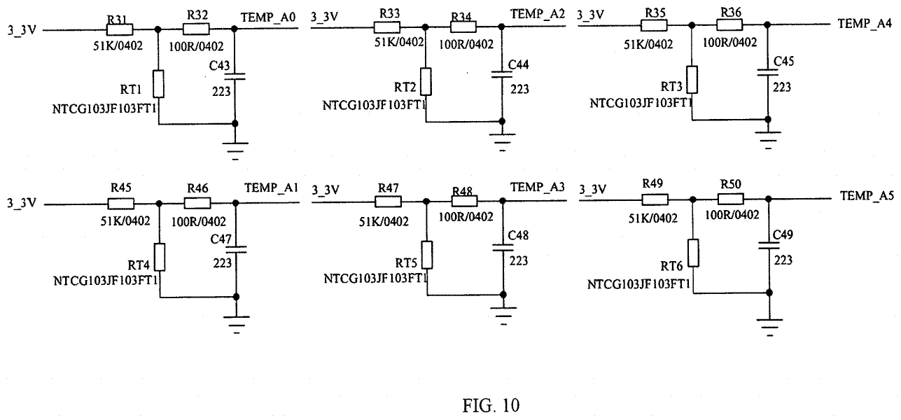

with reference to FIGS. 6 and 8, the auxiliary power circuit reduces the voltage provided by the power input circuit to 3.3V through a DC-DC chip, and provides power for the temperature sampling circuit, the LED indicator circuit, the ambient light monitoring circuit, and multiple inverter network circuit groups; alternatively, the DC-DC chip in the embodiment is composed of two ICME3116AM6G;
with reference to FIG. 10, the temperature sampling circuit samples the temperature in the bottom case and the upper cover through several thermistors and transmits the temperature signal to the MCU main control circuit; the MCU main control circuit controls whether the entire device continues to work according to the temperature signal; alternatively, in the embodiment, when the internal temperature of the product reaches 55° C., the entire system is shut down through the MCU main control circuit and the product stops working;

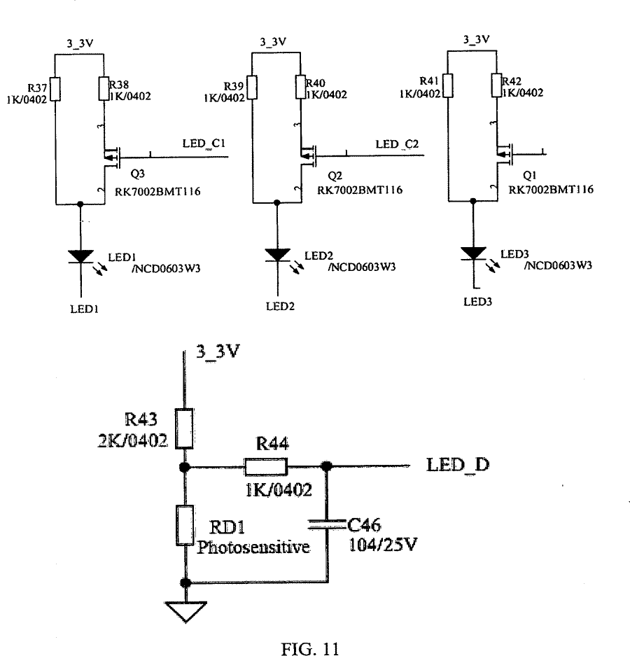

with reference to FIG. 11, the LED indicator circuit is provided with several status indicators 7, and the status indicators 7 are embedded on the side wall of the bottom case; the ambient light monitoring circuit collects the ambient light source through several photoresistors and transmits the light source signal to the MCU main control circuit, and the MCU main control circuit sends a light brightness adjustment signal to the LED indicator circuit according to the light source signal, so as to adjusts the brightness of the charging status indicator to adapt to the environment.

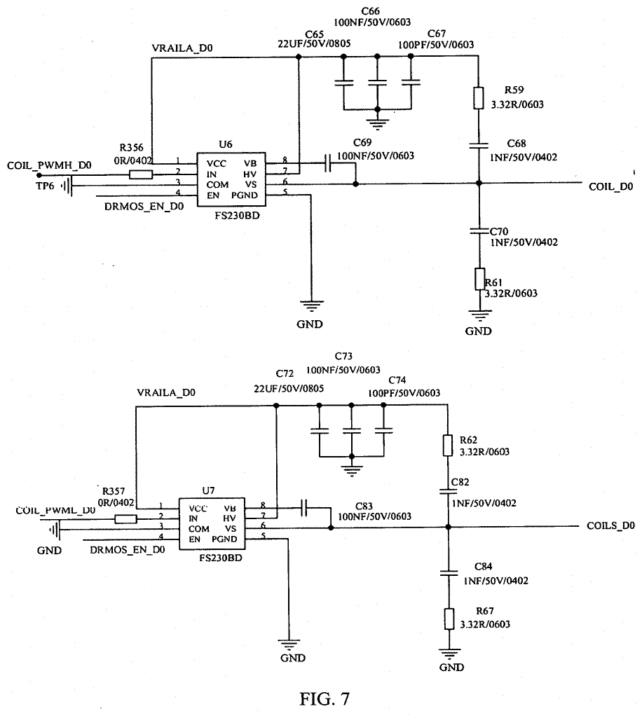

With reference to FIG. 7, the inverter network circuit is a full bridge inverter network circuit composed of two half bridges, and controls the inverter circuit input current sampling circuit and the inverter circuit input voltage sampling circuit to sample real-time parameters of each coil.

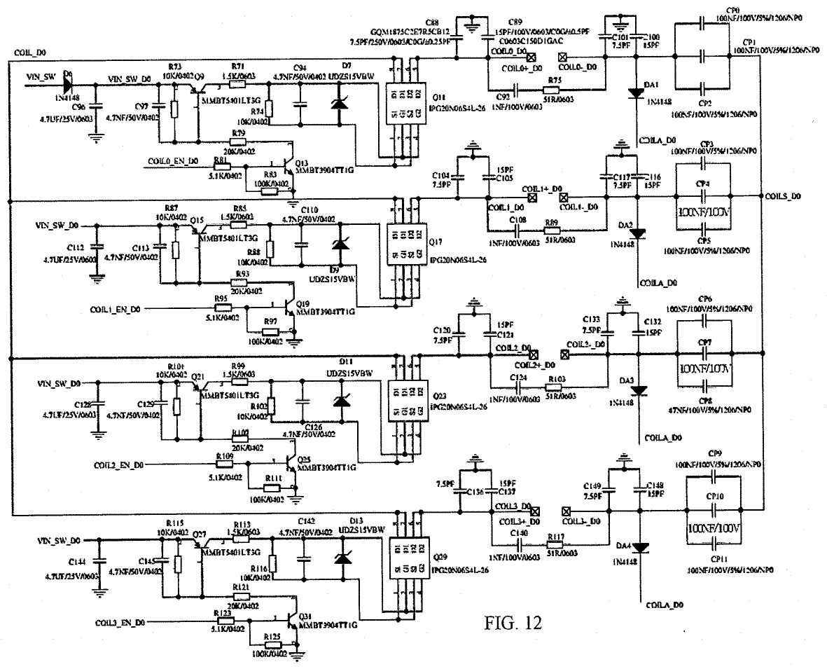

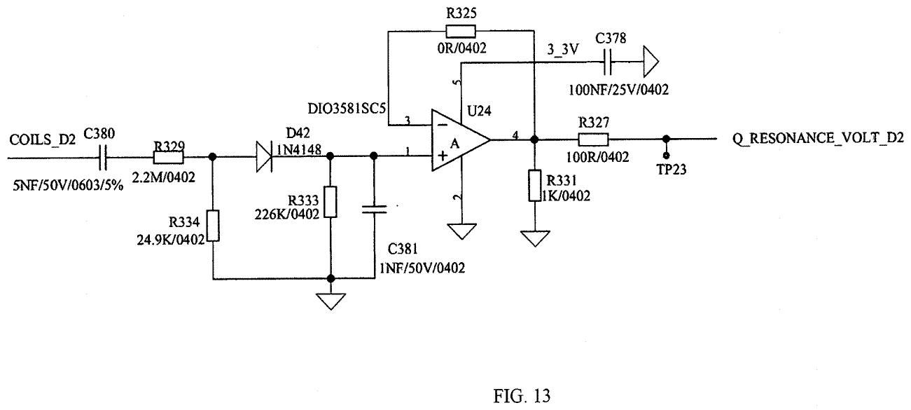

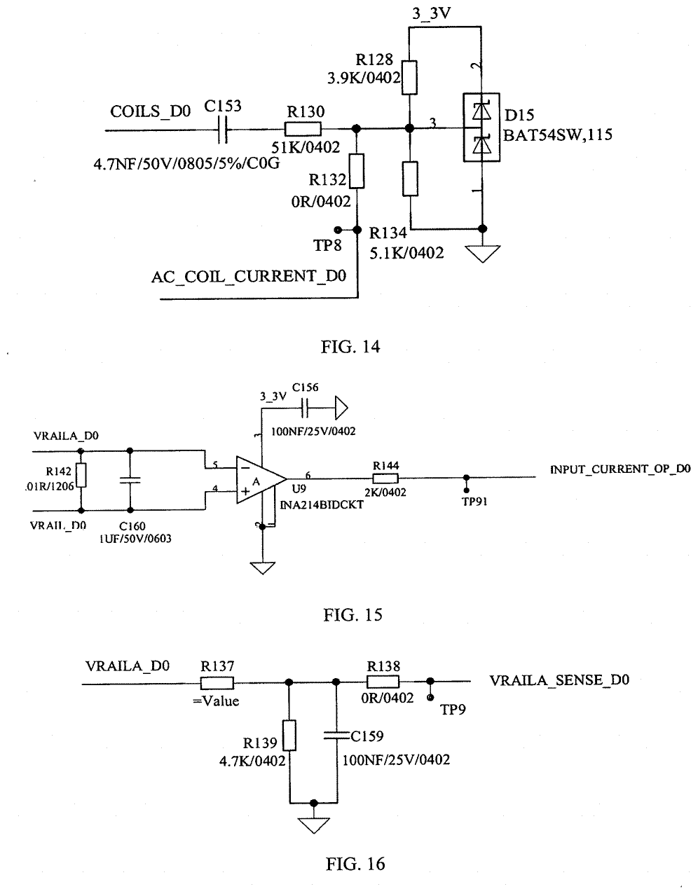

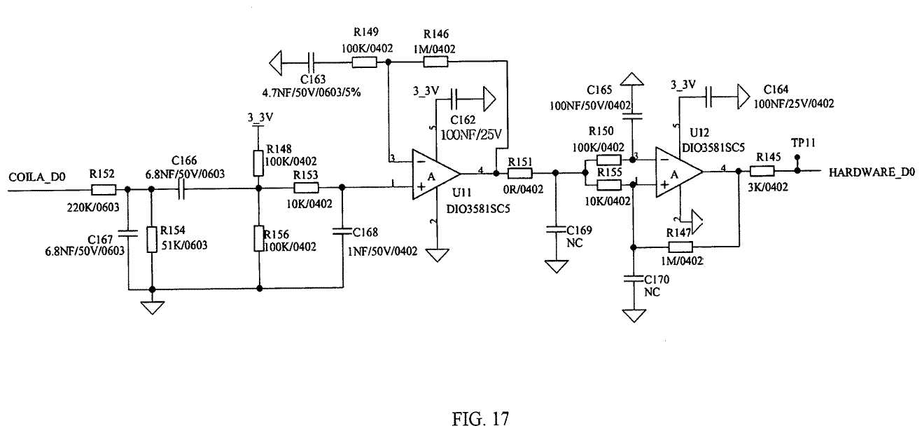

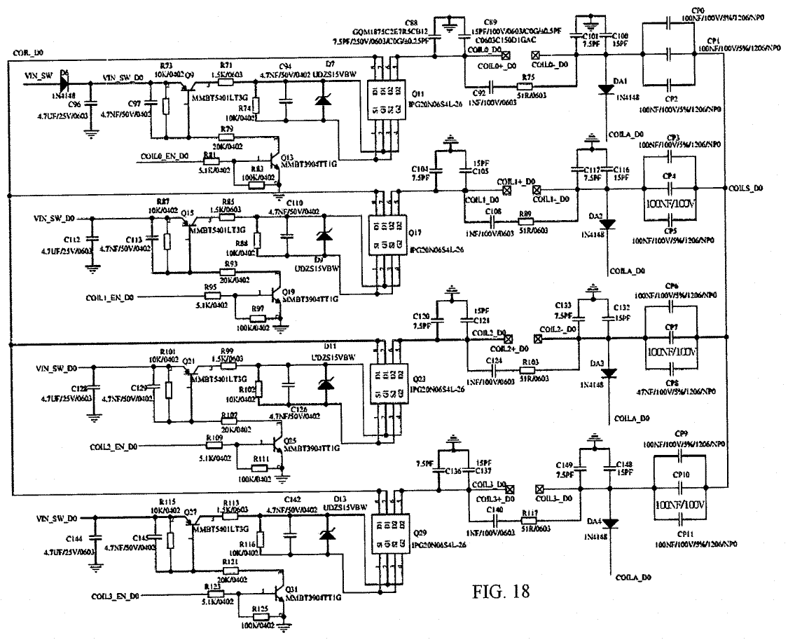

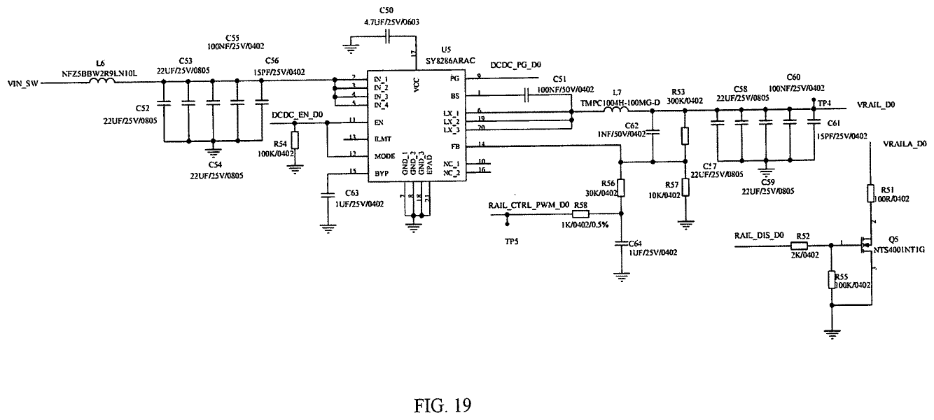

With reference to FIG. 12-20, when the charged device is magnetically coupled on the charging device, the inverter network circuit of the PCB main control board corresponds to each coil in the corresponding coil circuit unit, and samples the real-time parameters of each coil through the inverter circuit input current sampling circuit and the inverter circuit input voltage sampling circuit and outputs signals to the MCU main control circuit before energy transmission; the MCU main control circuit judges the working parameters of each coil, and controls the coil with the strongest magnetic field coupling capability of the charged device as the working coil for energy transmission through the coil selection circuit;
when the selected working coil starts to work, the MCU main control circuit closes the coils of other groups adjacent to the working coil, so that other coils in the same group will no longer work, which avoids dangerous situations, and avoids communication crosstalk when two devices are working;
in the working coil, the coil voltage sampling circuit and the coil current sampling circuit of the PCB main control board sample parameters of the working coils and output signals to the MCU main control circuit; the sampled parameters include the voltage and current status of the coil when it is working; the MCU main control circuit judges whether the coil is working normally according to the parameters transmitted by it;
the demodulation circuit extracts the carrier communication signal attached to the coil voltage and sends it to the MCU main control circuit; the synchronous DC voltage adjustment circuit adjusts the voltage on the input of the inverter network circuit through the PWM control output of the MCU main control circuit.

The coil carrier board 4.1 is connected to the PCB main control board 3 through self-tapping screws 5, and the PCB main control board 3 is connected to the bottom case 1 through self-tapping screws 5; the outer surface of the bottom case 1 is further provided with several silica gel filler strips 6.

The status indicators 7 are provided on the side wall of the bottom case 1 through a sponge pad 8.

The temperature sampling circuit, the LED indicator circuit, and the ambient light monitoring circuit on the MCU main control circuit are multiple. Various information under the working status of the board is collected in real time and sent to the MCU for processing to ensure that the system is safe and stable during operation. The sampling of each group of inverter network is independent of each other, and the normal operation of other groups will not be affected when one group of device triggers protection.

The 22 coils used in the device combine a larger charging area; the wireless charging device can be placed at will in the charging area without special alignment. The MCU main control circuit will intelligently identify and detect the position of the corresponding coil, turn on the corresponding coil device for intelligent charging, and monitor the charging status of the device at any time during the charging process to ensure reliable completion of each charging work. The device can charge up to three Qi devices simultaneously.

The invention and its embodiments are described hereinabove, and the description is not restrictive. What is shown in the drawings is only one of the embodiments of the invention, and the actual structure is not limited thereto. All in all, structural modes and embodiments similar to the technical solutions without deviating from the inventive purpose of the invention made by those of ordinary skill in the art without creative design shall all fall within the protection scope of the invention.

1. A 22-coil wireless charging device capable of charging for three devices simultaneously, comprising a bottom case and an upper cover that are provided oppositely, a PCB main control board provided in the bottom case, and a coil block provided on the PCB main control board and electrically connected thereto; wherein the coil block comprises a coil carrier board and at least two layers of coil circuit groups stacked on the coil carrier board; the coil circuit groups are divided into 3 groups of coil circuit units along the length direction of the charging device;
the PCB main control board is provided with an MCU main control circuit, a power input circuit electrically connected to the MCU main control circuit, an auxiliary power supply circuit, a temperature sampling circuit, an LED indicator circuit, an ambient light monitoring circuit, and multiple groups of inverter network circuit groups corresponding to the coil units one-to-one; the inverter network circuit group comprises an inverter network circuit connected to the coil circuit unit, an inverter circuit input current sampling circuit, an inverter circuit input voltage sampling circuit, a coil voltage sampling circuit, a coil current sampling circuit, a demodulation circuit, a coil selection circuit, and a synchronous DC voltage adjustment circuit;
when the charged device is magnetically coupled on the charging device, the inverter network circuit corresponds to each coil in the corresponding coil circuit unit, and samples the real-time parameters of each coil through the inverter circuit input current sampling circuit and the inverter circuit input voltage sampling circuit and outputs signals to the MCU main control circuit before energy transmission; the MCU main control circuit controls the coil with the strongest magnetic field coupling capability of the charged device for energy transmission through the coil selection circuit; at the same time, the coil voltage sampling circuit and the coil current sampling circuit sample parameters of the working coils and output signals to the MCU main control circuit; the demodulation circuit extracts the carrier communication signal attached to the coil voltage and sends it to the MCU main control circuit; the synchronous DC voltage adjustment circuit adjusts the voltage on the input of the inverter network circuit through the PWM control output of the MCU main control circuit.

2. The 22-coil wireless charging device capable of charging for three devices simultaneously according to claim 1, wherein the coil circuit group is provided with 22 coils in total; after being divided into 3 groups of coil circuit units, each group of coil circuit units sequentially contains 8, 8, and 6 coils, and the adjacent ends of each group of coil circuit units are provided with overlapping areas.

3. The 22-coil wireless charging device capable of charging for three devices simultaneously according to claim 1, wherein the input end of the power input circuit is provided with a Type-c interface, and a communication protocol is proceed with a power adapter through a PD chip.

4. The 22-coil wireless charging device capable of charging for three devices simultaneously according to claim 1, wherein the auxiliary power circuit reduces the voltage provided by the power input circuit to 3.3V through a DC-DC chip, and provides power for the temperature sampling circuit, the LED indicator circuit, the ambient light monitoring circuit, and multiple inverter network circuit groups.

5. The 22-coil wireless charging device capable of charging for three devices simultaneously according to claim 1, wherein the temperature sampling circuit samples the temperature in the bottom case and the upper cover through several thermistors and transmits the temperature signal to the MCU main control circuit.

6. The 22-coil wireless charging device capable of charging for three devices simultaneously according to claim 1, wherein the LED indicator circuit is provided with several status indicators, and the status indicators are embedded on the side wall of the bottom case.

7. The 22-coil wireless charging device capable of charging for three devices simultaneously according to claim 1, wherein the ambient light monitoring circuit collects the ambient light source through several photoresistors and transmits the light source signal to the MCU main control circuit, and the MCU main control circuit sends a light brightness adjustment signal to the LED indicator circuit according to the light source signal.

8. The 22-coil wireless charging device capable of charging for three devices simultaneously according to claim 1, wherein the inverter network circuit is a full bridge inverter network circuit composed of two half bridges.

9. The 22-coil wireless charging device capable of charging for three devices simultaneously according to claim 1, wherein the coil carrier board is connected to the PCB main control board through self-tapping screws, and the PCB main control board is connected to the bottom case through self-tapping screws; the outer surface of the bottom case is further provided with several silica gel filler strips.

10. The 22-coil wireless charging device capable of charging for three devices simultaneously according to claim 1, wherein the status indicators are provided on the side wall of the bottom case through a sponge pad.
